(19) United States
(12) Patent Application Publication
(10) Pub. No.: US 2025/0377054 A1
(43) Pub. Date: Dec. 11, 2025

(54) GUIDE DEVICE FOR GUIDING AT LEAST ONE CABLE PLACED IN A PROTECTIVE HOSE, AND RETROFIT KIT AND METHOD FOR MONITORING MOVEMENT OF SUCH A PROTECTIVE HOSE

(71) Applicant: BizLink Industry Germany GmbH, Roth (DE)

(72) Inventors: Asraful KABIR, Hannover (DE); Wei LIN, Hannover (DE); Fatih OEZEL, Hannover (DE)

(21) Appl. No.: 19/308,397

(22) Filed: Aug. 25, 2025

Related U.S. Application Data
(63) Continuation of application No. PCT/EP2024/054914, filed on Feb. 27, 2024.

(30) Foreign Application Priority Data
Feb. 28, 2023 (DE) 10 2023 201 837.3
Dec. 1, 2023 (DE) 10 2023 212 090.9

(51) Int. Cl. F16L 3/01; B25J 19/06

(52) U.S. Cl. CPC F16L 3/01; B25J 19/06

(57) ABSTRACT

A guide device for guiding at least one cable placed in a protective hose, in particular of a joint arm robot, includes a guide unit having a fastening element for securing the protective hose, and a static support. The fastening element is movable along the support to allow a compensating movement of the protective hose and the at least one cable guided therein. A sensor device is configured to measure the movement of the protective hose and thus detect movement data of the protective hose. A proper operation of the guide device is therefore monitored. In particular, the protective hose is monitored for damage. A retrofit kit for forming the guide device, and a method for monitoring a movement of a protective hose of a guide device, are also provided.

### CROSS-REFERENCE TO RELATED APPLICATION

This application is a continuation, under 35 U.S.C. § 120, of copending International Patent Application PCT/EP2024/054914, filed Feb. 27, 2024, which designated the United States; this application also claims the priority, under 35 U.S.C. § 119, of German Patent Applications DE 10 2023 201 837.3, filed Feb. 28, 2023 and DE 10 2023 212 090.9, filed Dec. 1, 2023; the prior applications are herewith incorporated by reference in their entirety.

### FIELD AND BACKGROUND OF THE INVENTION

The invention relates to a guide device for guiding at least one cable which is disposed in a protective hose, as well as to a retrofit kit and to a method for monitoring the movement of such a protective hose.

The guide device is used in particular to guide a so-called hose package in a multi-axis articulated-arm robot, particularly in a multi-axis industrial robot. In the multi-axis industrial robots used today, a plurality of individual cables are usually fed to the front articulated arm, also known as the robot hand, to supply a tool disposed on the robot hand with power, for example a welding tool. The cables include, for example, electrical supply cables, electrical control cables, data cables, and media conduits for gases or liquids. Those cables are grouped together in a so-called hose package and are usually disposed loosely in a protective hose. Such a hose package is exposed to high loads due to the movements of the articulated arms relative to one another and, in particular, due to the oftentimes adverse environmental conditions (high temperatures, aggressive media such as welding spatter, etc.). The protective hose in particular is exposed to high levels of stress. A so-called corrugated pipe is often used as a protective hose.

In order to make reliable guidance of the hose package possible, a guide device with a return mechanism is usually used which is configured in such a way that a compensating movement of the hose package is possible during a relative movement between two articulated arms. Such a guide device for an industrial robot is known, for example, from European Application EP 2 956 277 A1, corresponding to U.S. Pat. No. 10,059,011 B2.

The high stresses on the protective hose can lead to damage to the protective hose, thus impairing its protective effect. If a damaged protective hose is not replaced or repaired in a timely manner, that can lead to failure of the cables routed in the protective hose and can result in a breakdown and downtime. In highly automated production plants and in industrial environments, a defective protective hose often cannot be detected in time, because there is no or only limited accessibility for visual inspection, for example.

### SUMMARY OF THE INVENTION

It is accordingly an object of the invention to provide a guide device for guiding at least one cable placed in a protective hose, and a retrofit kit and a method for monitoring movement of such a protective hose, which overcome the hereinafore-mentioned disadvantages of the heretofore-known devices, kits and methods of this general type and which ensure reliable operation of such a guide device and, in particular, enable a defect in a protective hose to be detected at an early stage.

With the foregoing and other objects in view there is provided, in accordance with the invention, a guide device for guiding at least one cable disposed within a protective hose, in particular of an articulated-arm robot, with a guide unit, wherein the guide unit has a static support and a fastening element for fastening the protective hose, the fastening element is movable along the support in order to enable a compensating movement of the protective hose and of the at least one cable guided therein, the guide device comprises a sensor device which, during operation with the mounted protective hose, is configured to at least indirectly measure the movement of the protective hose and thereby capture movement data of the protective hose.

With the objects of the invention in view, there is also provided a retrofit kit for forming a guide device according to the invention, wherein the retrofit kit comprises a sensor device which can be mounted on a guide unit and which is configured to measure the movement of a protective hose of the guide unit.

With the objects of the invention in view, there is concomitantly provided a method for monitoring the movement of a protective hose of a guide device which serves to guide at least one cable disposed in the protective hose, wherein the guide device has a guide unit with a fastening element for fastening the protective hose and with a static support, the fastening element is movable along the support to enable a compensating movement of the protective hose and of the at least one cable guided therein, and a movement of the protective hose relative to the support is measured and movement data are captured.

The advantages and preferred embodiments mentioned with regard to the guide device can also be applied analogously to the retrofit kit and to the method, and vice versa.

The guide device generally serves the purpose of guiding at least one cable located in a protective hose, in particular a cable of a multi-axis articulated-arm robot, especially of a multi-axis industrial robot, to which the guide device is attached during operation. In general, the guide device is fastened in the assembled state to a processing machine which has at least two machine parts that are movable relative to one another. The at least one cable, preferably plurality of cables, and the protective hose form a hose package. The cable and the protective hose are not mandatory but are preferably part of the guide device. When assembled and in operation, the protective hose is mounted on the guide device and is at least then part of the guide device.

The guide device has a guide unit which extends in a longitudinal direction and includes a fastening element to which the protective hose is fastened during operation. Furthermore, the guide unit includes a static support which is preferably fixed in place on the articulated-arm robot when in the assembled state. The guide unit is, in particular, an independent, compact unit which, as such, can be mounted on a machine, in particular on an articulated-arm robot, for example by using the support. For example, the support is a base plate of a housing of the guide unit. In principle, there is also the possibility that the support itself be part of the machine. The guide unit is, for example, a known guide unit such as that described, for example, in the aforementioned European Application EP 2 956 277 A1, corresponding to U.S. Pat. No. 10,059,011 B2.

During operation, the protective hose attached to the fastening element is moved along the support relative thereto. Specifically, the fastening element is mounted on the support such that it is displaceable, in particular linearly, in order to make possible a compensating movement of the protective hose and of the at least one cable guided therein during operation.

Furthermore, the guide device has a sensor device which is configured to at least indirectly measure the movement of the protective hose and thereby capture movement data, in particular movement patterns, of the protective hose during operation with the protective hose mounted. In general, the movement of the protective hose, in particular of the fastening element, is detected over time, specifically within the framework of a duty cycle in which a defined movement is carried out with the guide device starting from a starting position via at least one processing position and back again to the starting position.

In particular, the actual movement of the protective hose and especially the movement relative to the wearer is measured and made available for evaluation. Preferably, therefore, a movement of the protective hose relative to a reference point of the wearer is measured.

Here, the expression “at least indirect measurement of the movement of the protective hose” means that the actual movement of the protective hose is measured either directly via a measuring reference on the protective hose or indirectly via a measuring reference on a separate component. The separate component is securely connected to the protective hose during operation. A measurement reference is a reference point or reference element whose movement is measured.

The separate component is, in particular, the fastening element or a part thereof. The special advantage is that this is a rigid component with a defined movement sequence which is especially well suited as a measurement reference and therefore for measurement.

Based on the captured movement data, in particular based on the detected movement pattern of the protective hose and in particular of the fastening element during the duty cycle, it is checked during operation whether the guide device and thus the articulated-arm robot are operating properly. During operation, the robot and thus the hose package usually performs periodically recurring work sequences that are specified by a robot or system control system. During such a duty cycle, the protective hose moves in a defined movement pattern. Specifically, within the scope of such a duty cycle, a deflection takes place from a starting position to an end position and, from there, back to the end position. Preferably, one or more intermediate positions are assumed at which the deflection stops, for example, for a certain period of time and/or at which a processing operation (e.g., welding, screwing, gripping, or other handling . . . ) takes place. After processing is completed, the robot moves to another intermediate position or end position and carries out another processing operation there.

The retrofit kit according to the invention includes such a sensor device which is configured for mounting on an (existing) guide unit. The retrofit kit therefore makes it easy to retrofit existing systems.

Specifically, the retrofit kit is a structural unit that can be mounted as such on the guide unit and/or on the articulated-arm robot. For this purpose, the unit has mounting elements for fastening. In particular, these include screws, clamps, etc. The preferred configuration of the mounting elements is one that allows for tool-free fastening. In particular, these are magnets, so that the sensor device is attached to the articulated-arm robot and especially to the guide unit exclusively by magnets.

This evaluation of the movement data is preferably carried out with the aid of an evaluation unit. Such a device is part of the guide device, for example. Alternatively, it is disposed on the articulated-arm robot or is part of it. According to another alternative, this evaluation unit is located remotely from the articulated-arm robot and is, for example, integrated into a system control system or integrated into a remote data center, for example in a cloud-based solution. In general, but especially in the case of such a remote arrangement of the evaluation unit, the sensor device and thus preferably also the retrofit kit has, in particular, a communication interface for transmitting the movement data or any processed movement data to the evaluation unit.

This configuration is based fundamentally on the insight that, during operation, the protective hose moves in a defined, predetermined movement pattern during the different movement sequences. The movement pattern is generally understood to mean the temporal progression of the movement of the protective hose, i.e., its change in position over time, especially within the framework of the aforementioned duty cycle. During proper operation, a characteristic curve of the movement data (position data, speed data, or acceleration data) results, especially of the movement pattern during a duty cycle. By measuring the actual movement of the protective hose relative to the wearer, movement data of the protective hose is now provided which is checked to determine whether there is a deviation from the expected movement pattern. In the event of a deviation—and depending on the type of deviation—a malfunction is assumed.

It is therefore preferable to detect the movement pattern during a duty cycle and compare it with a reference pattern. The reference pattern is provided, for example, by the manufacturer of the guide device or measured and then stored when the guide device is put into operation.

In particular, the movement pattern and the reference pattern are based on the identical duty cycle, which is usually specified by the robot or system control. Therefore, a complete movement sequence is compared with an expected movement sequence with identical actuation.

In a preferred embodiment, a check is provided with regard to a deviation of the movement data captured during the measurement, in particular of the detected movement pattern, from reference data, especially from the mentioned reference pattern.

Such a comparison enables deviations from an expected target course to be identified and, in particular, inferences to be made about the proper operation of the guide device and, in particular, of the articulated-arm robot.

In particular, the captured movement data are evaluated for damage to the protective hose. If the protective hose is damaged, and especially if it is torn, this typically results in a deviation from the movement pattern. For example, if the protective hose is torn, the deflection required to enable the desired movement is less than with an intact protective hose. This is therefore characteristically expressed in the movement pattern. A defective protective hose can be easily identified by comparing the expected (maximum) deflection and the measured (maximum) deflection.

In particular, the measured deflection at the end position and/or the intermediate position in the movement pattern is compared with the expected deflection at these positions in the reference pattern.

Alternatively or in addition to the deflection, for example, the increase (speed, acceleration) in individual sections of the movement pattern—i.e., between the individual positions (initial, intermediate, and end position) within the duty cycle—is evaluated and considered.

Alternatively or in addition to these measured movement data (such as deflection, speed, acceleration . . . ), statistical parameters are determined and evaluated as movement data, especially when measurements of movement patterns are repeated during the same duty cycle. These are, for example, minima/maxima, and/or a standard deviation/variance of the measured movement data (such as deflection, speed, acceleration . . . ).

In a preferred embodiment, multiple different types of movement data and characteristics are captured or determined and evaluated. Different types of movement data are understood to mean different parameters, especially different physical parameters such as speed, acceleration, etc., or mathematical or statistical parameters derived therefrom. Specifically, the minimum/maximum of the deflection and/or preferably also statistical values such as mean, variance, and/or even a cycle time are captured and evaluated.

By capturing/determining multiple characteristic parameters, the accuracy in identifying possible cases of damage and/or the accuracy in distinguishing between different events or cases of damage is increased.

Overall, this means that damage, such as a tear in the protective hose, can be reliably detected at an early stage and, in particular, without visual inspection, enabling it to be replaced or repaired in a timely manner, in particular before the components inside the protective hose are damaged. Overall, this provides a simple method for monitoring the movement of a protective hose, which makes early identification of damage to the protective hose possible.

In addition, measuring the movement of the protective hose and, especially, evaluating the movement data enables further inferences to be made about the operation of the guide device, in particular about the operation of the articulated-arm robot as a whole.

In a preferred refinement, movement data are evaluated additionally or alternatively for a malfunction of the guide device and/or machine.

For example, there is a risk of the hose package or even just the cables emerging from the protective hose getting caught on an interfering contour during the various movements, so that the intended movement of one machine part—of a robot hand, for example—cannot be carried out or cannot be carried out completely. For example, ring-shaped projectors are usually disposed on the protective hose which enclose the protective hose and provide protection from friction. These projectors or other parts of the protective hose can get caught on protruding (interfering) contours. If this is the case, it may indicate incorrect actuation and thus incorrect programming of the articulated-arm robot. In a preferred embodiment, the captured movement data are therefore also checked for such faults in the actual movement sequence and/or for incorrect programming.

In a preferred embodiment, it is checked on the basis of the movement data whether the movement pattern has been changed. This may be due, for example, to changed programming that has changed the deflection, speed, acceleration, and/or cycle time.

In such a case, when a change in the movement pattern is detected (due to a change in the programming), a warning message is preferably issued.

This can be an optical warning message via light elements (LEDs) on the guide device, for example. Preferably, it is an electronic warning message that is transmitted to a remote communication unit and/or stored locally in a memory. Such a communication unit is a user interface, for example, such as a customer dashboard. Alternatively, such an electronic warning message can be sent to mobile devices (smartphones), e.g., as push messages/SMS, etc. According to a preferred embodiment, the warning message is transmitted, for example, from the evaluation unit to a user system or a system control of a user who is operating the articulated-arm robot and from where the articulated-arm robot is, in particular, also being actuated.

Different warning messages are preferably issued depending on the changes detected. This ranges, for example, from mere indications of possible programming changes to recommendations for action in the event of a tear being detected.

In a preferred embodiment, the sensor device has two sensor components for measuring the movement, one sensor component being disposed in a stationary manner and the other sensor component being connected at least indirectly to the protective hose and in particular to the fastening element, so that during operation the two sensor components execute a relative movement which corresponds in particular to the relative movement to be measured between the support and the protective hose. The stationary sensor component is preferably securely connected to the support. Alternatively, it can be attached to a section of the guide unit housing or to the articulated-arm robot.

The two sensor components are also part of the retrofit kit. The aforementioned mounting elements are configured in such a way that one movable sensor component can be mounted at least indirectly on the protective hose and the other stationary sensor component can be mounted on the support, housing, or articulated-arm robot. This is achieved specifically by using a magnetic attachment, for example.

The movable sensor component is preferably securely connected to the fastening element in the assembled state, for example by using a connecting element. Since the protective hose is fixed to the fastening element, the one movable sensor component directly follows the movement of the protective hose.

As an alternative to being attached to the fastening element, the movable sensor component can also be attached to the protective hose itself, for example by using a clip. Attachment to the fastening element is preferred, however, because this is a rigid element whose movement sequence is defined. Preferably, the fastening element only performs a linear movement.

In a preferred embodiment, one of the two sensor components is a reflector on which a sensor signal to be measured is reflected. The reflector is configured appropriately depending on the sensor signal (measurement signal).

Preferably, the sensor device generally includes a transmitter and a receiver for the sensor signal. The sensor signal is actively transmitted via the transmitter and received by the receiver. The received sensor signal is then evaluated appropriately, for example with regard to its propagation delay, in order to evaluate the desired movement data, such as positional change, speed, acceleration, etc.

Depending on the embodiment, the transmitter and receiver are disposed in a common unit or at least at the same (starting) position. In this structural variant, the aforementioned reflector is additionally provided in order to reflect the sensor signal back to the starting position.

Alternatively, the sensor and receiver are positioned remotely from one another, with one sensor component being stationary and the other sensor component being movable. With this structural variant, a reflector is not necessary.

In a preferred embodiment, the two sensor components—i.e., the stationary and the movable sensor component—are housed in a sensor housing. They are preferably accommodated completely or at least partially in the sensor housing. This measure ensures that the sensor device is disposed so as to be protected overall and from environmental influences in particular. At the same time, back reflections from objects in the detection area are avoided, for example in the case of spurious sensor signals. This ensures reliable and correct measurements overall.

This sensor housing is preferably also part of the retrofit kit. The retrofit kit thus includes the sensor housing, with both the stationary sensor component and the movable sensor component disposed therein. The movable sensor component is therefore also disposed so as to be movable relative to the sensor housing. For this purpose, the sensor housing preferably has a (linear) guide along which the movable sensor component can be moved within the sensor housing. This guide is, for example, a guide slot in a side wall of the sensor housing, a separate guide element within the sensor housing, and/or side walls of the sensor housing.

In a preferred embodiment, the one movable sensor component is connected to the protective hose, at least indirectly via the fastening element, via a connecting element which protrudes from the sensor housing. This connecting element is an afore-described mounting element of the retrofit kit, for example, or it is connected to such a mounting element.

The sensor housing is preferably a standalone housing which, when mounted, is mounted in particular to the side of the guide unit. Preferably, the sensor housing is attached to the support via corresponding mounting elements, which in particular are part of the retrofit kit.

As an alternative to the arrangement of the sensor device or at least the sensor components within a separate sensor housing, the sensor components are disposed on and, in particular, within the guide unit. In this case, the guide unit itself preferably has the aforementioned housing with an interior in which the sensor components are disposed and thus protected from the environment.

In principle, different measuring principles are possible for detecting the movement, especially the relative movement between the support and the protective hose.

According to an advantageous embodiment, the sensor device is configured for an ultrasonic measurement, and the sensor component is an ultrasonic transmitter. Another sensor component is an ultrasonic receiver. Preferably, the movable sensor component is a reflector for the ultrasonic signal (sensor signal).

Alternatively, the sensor device is configured for optical measurement, and one sensor component is an optical transmitter and another sensor component is an optical receiver. Specifically, these are semiconductor components, in particular an LED as a transmitter and a photodiode as a receiver.

Here too, in a preferred embodiment, a reflector is provided as a movable sensor component.

According to another preferred variant, the sensor device is configured for an electrical or an electromagnetic measurement and, in particular, for a capacitive or inductive measurement. Different configurations are possible in principle. For a capacitive or inductive measurement, one or more electrical components such as electrodes, electromagnetic coils, (permanent) magnets, etc., are disposed so as to be distributed along the displacement path of the protective hose/fastening element, for example on the support or on another stationary component of the guide unit, for example on a housing lid forming a housing cover. Complementary thereto, a second electrical or electromagnetic component such as an electrode, an electromagnetic coil, or a (permanent) magnet is disposed on the protective hose and especially on the fastening element. For example, the elements disposed along the displacement path each result in a counting pulse, and the movement can be deduced from the counting pulses. As an alternative to the arrangement of discrete individual electrical/electromagnetic components, a continuous component with a changing characteristic can also be disposed over the displacement path. For example, a continuous electrode is formed whose width changes continuously, so that when a counter electrode that is disposed, for example, on the fastening element is moved, a capacitance measured between the two electrodes changes continuously and, based on the capacitance value captured in each case, a defined position and thus a movement over time can be inferred.

According to a preferred embodiment, the sensor device has a mechanical auxiliary element, in particular a cord, which is connected at least indirectly to the protective hose and, for example, to the fastening element and can be moved together therewith. In a preferred embodiment, the cord is attached to the protective hose by using a clip.

The sensor device is further configured to measure the movement of the mechanical auxiliary element. The term “cord” is generally understood to be a flexible, strand-like element. This can be a cord in the narrow sense, or a band, a chain, a strap, etc. The cord can also be guided over a pulley or wound up using a winding mechanism. Specifically, a cord sensor is used which detects the mechanical movement of the cord. For example, the winding and unwinding movement of a winding mechanism is evaluated.

As an alternative to a cord, a rigid mechanical element such as a rod can be provided which moves together with the protective hose or the fastening element and whose movement is detected.

The guide unit generally has a return mechanism which is configured for the automatic, in particular spring-operated, return of the protective hose to a starting position. The spring-operated return mechanism exerts a preload on the protective hose, especially via the fastening element. A deflection of the hose package from the starting position occurs as a result of a forced movement of the processing machine, especially of the articulated-arm robot, for example during a forced movement of the robot hand to which at least one cable is attached.

This retrieval mechanism is particularly attached to the support.

The fastening element further includes a sliding element on which the return mechanism exerts the return force. The sliding element is in particular a carriage which is guided along a guide, in particular a linear guide.

The return mechanism is housed in the housing of the guide unit. This housing has at least one slot and preferably two opposing lateral longitudinal slots. Through at least one slot, the internal sliding element is connected to a fastening clip for the purpose of fastening the protective hose. The sliding element and fastening clip form the fastening element or are at least part of the fastening element. Preferably, the fastening element generally has such a fastening clip for clamping the protective hose in place.

The fastening element has, in particular, a bracket which surrounds the housing cover and whose edge-side bracket arms engage into the interior of the housing via the two mentioned lateral longitudinal slots and are connected there to the return mechanism, specifically to the sliding element.

The aforementioned movable sensor component is preferably securely connected to this bracket.

In a preferred development, the guide device has at least one sensor element and preferably multiple sensor elements as well as one or the evaluation unit. The sensor elements are configured to capture sensor data which correlate with the condition of the protective hose, thus enabling inferences to be made about the current condition of the protective hose.

The sensor data preferably are formed, at least in part, of the movement data of the protective hose. The sensor elements are therefore, at least in part, the sensor components described above.

Alternatively, and particularly in addition, further sensor data, such as temperature data and/or humidity data, are used which are captured by using suitable (additional) sensor elements, such as temperature sensors, humidity sensors, etc. The temperature is particularly the ambient temperature and/or the temperature of the protective hose.

The evaluation unit, in conjunction with the sensor elements, is configured to repeatedly capture the sensor data during operation and to evaluate them with regard to the current wear condition of the protective hose. If this evaluation indicates a critical wear condition, a warning message is issued or at least stored in a memory.

Repeated capture means that the data are acquired regularly at specific times, for example periodically after a certain period of time, during operation in order to obtain information about the current wear condition. The duration of the periodic capture of the sensor data is, for example, in the range of seconds or even milliseconds, particularly in the range of 10 to 20 milliseconds. The duration of the periodic evaluation of the sensor data is, for example, in the range of minutes, preferably from 1 to 20 minutes, in particular from 1 to 10 minutes, especially from 1 to 3 minutes.

This measure makes continuous monitoring of the wear condition of the protective hose possible. Overall, this creates an early warning system. This measure offers the special advantage of enabling early detection of critical wear and tear, so that timely repair or replacement can be carried out. This prevents damage and/or downtime due to failure of the protective hose.

In a preferred embodiment, one or both of the following steps are carried out during the evaluation:
a) The sensor data are processed using a filter algorithm such that noise components, interference signals, and/or irrelevant signal components that are not relevant particularly to assessing the wear condition of the protective hose are filtered out, and filtered sensor data are obtained.
b) Predefined characteristic values are extracted from the sensor data, in particular from the filtered sensor data, using an extraction algorithm.

The current wear condition of the protective hose is preferably derived from these extracted parameters.

These steps enable an accurate assessment of the current wear condition of the protective hose to be achieved reliably and, in particular, with minimal computational complexity.

In particular, the specified parameters may be one or both of the following parameters:
a) from the progression of the sensor data over time, a minimum or a maximum of the progression is used as a characteristic value;
b) the sensor data are subjected to a statistical evaluation, and a statistical characteristic value, particularly the variance or standard deviation of a measurement parameter, is used as a characteristic value, the values of the measurement parameter being provided by the sensor data.

Preferably, additional characteristic values can be captured and/or extracted and evaluated within the framework of the procedure. Preferably, up to 15, in particular up to 35 and especially up to 50 characteristic values can be captured and/or extracted and evaluated.

In a preferred refinement, the evaluated sensor data are compared with reference data, and the wear condition is inferred from the comparison. This allows for a simple and quick evaluation.

In a preferred embodiment, the reference data are determined from sensor data obtained during a learning phase after installation of the guide device. The duration of the learning phase is, for example, one or more years (e.g., 1-3 years), preferably a few months (e.g., a period of 1 to 6 months), or even weeks (e.g., a period of 1 to 4 weeks) or even days (e.g., a period of 1 to 14 days).

The evaluation for the wear condition takes place during a monitoring phase following the learning phase. The monitoring phase can also serve as a learning phase during operation of the guide device, so that interference factors occurring during long-term operation can be filtered out and detection and monitoring accuracy can thus be increased.

For the evaluation of the sensor data for the assessment of the wear condition, a self-learning algorithm, specifically based on AI (artificial intelligence), is preferably used. This applies in particular to the learning phase and/or monitoring phase.

The evaluation of the sensor data is carried out locally on site, for example, using an evaluation unit that is part of the guide device and/or part of a control system of the articulated-arm robot to which the guide device is attached.

Alternatively, the evaluation takes place at a remote location and, in particular, within a cloud system. This means that, in particular, a communication interface is implemented via which the sensor data or values derived therefrom are transmitted to the cloud system, in particular via the internet, and evaluated there appropriately. This cloud system is, for example, a remotely accessible storage space provided by the manufacturer of the guide device.

Preferably, the (additional) evaluation unit for carrying out the evaluation of the sensor data is integrated within the cloud system.

The reference data are expediently taken from the sensor data of multiple guide devices, which are disposed in particular at different locations, their sensor data being jointly captured and evaluated in the aforementioned remote storage, particularly in the cloud system. The reference data are then determined therefrom, for example as values averaged over multiple guide devices.

Other features which are considered as characteristic for the invention are set forth in the appended claims.

Although the invention is illustrated and described herein as embodied in a guide device for guiding at least one cable placed in a protective hose, and a retrofit kit and a method for monitoring movement of such a protective hose, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a simplified, diagrammatic, side-elevational view of an industrial robot with a guide device;

FIG. 2 is a perspective view of a guide device without a hose package but with a first sensor device;

FIG. 3 is a plan view of the guide device according to FIG. 2, but with various additional sensor devices which are shown together in FIG. 3 only for purposes of illustration;

FIG. 4 is a simplified representation of a movement pattern in which the location is plotted against time, for the case of an undamaged protective hose and for the case of a damaged protective hose in comparison; and

FIG. 5 is a simplified block diagram illustrating a monitoring and early warning system.

### DETAILED DESCRIPTION OF THE INVENTION

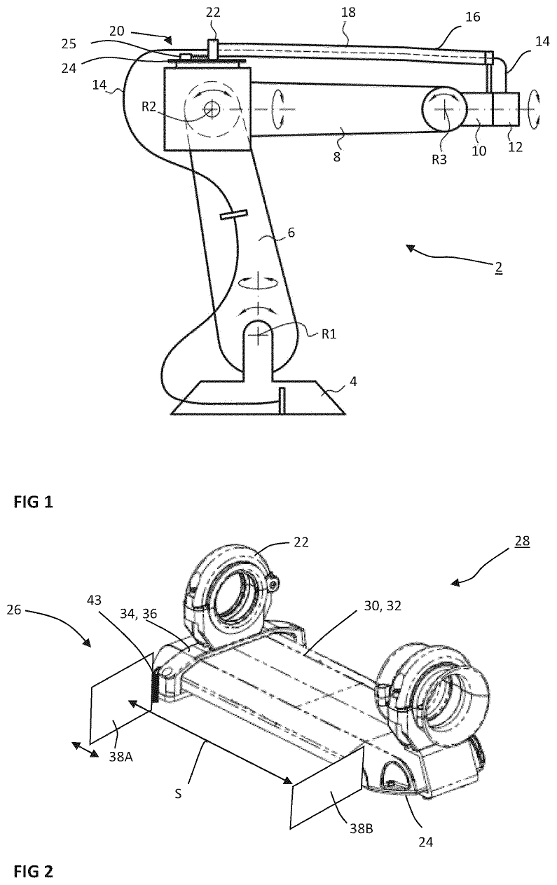

Referring now to the figures of the drawings in detail and first, particularly, to FIG. 1 thereof, there is seen an articulated-arm robot 2 configured as a processing machine, particularly in an embodiment configured as a multi-axis, in particular six-axis, industrial robot. It generally includes a base 4 and a first segment, also referred to as a rocker 6, which is connected to the base 4 via a first articulated joint R1. The rocker 6 can be pivoted about a horizontal axis around this first articulated joint R1. In addition, the rocker 6 is usually pivotable about a vertical axis relative to the base 4. The rocker 6 extends upward approximately vertically. At a second articulated joint R2, a second segment, generally referred to as a robot arm 8, is connected to the rocker 6 so as to be pivotable about a so-called “axis 3.” Furthermore, as a third segment, a robot hand 10 is connected to the robot arm 8 via a third articulated joint R3. Finally, a processing tool 12, such as a welding gun, etc., is attached to the robot hand 10. Such an industrial robot typically has more than four or more than five and, for example, six different degrees of freedom of movement.

In order to supply the processing tool 12 with electricity and/or fluids and/or data signals, the articulated-arm robot 2 has a supply cable package which is guided along the robot arm 2 and, from there, is connected to the base 4, for example. The supply cable package has at least one cable 14 and preferably multiple cables 14 which are guided in a protective hose 16 at least in the vicinity of the robot arm 8. The cables 14 together with the protective hose 16 are hereinafter also referred to as the hose package 18. Frequently, a separation point for the supply cable package is disposed in the vicinity of the second articulated joint R2, and the hose package 18 is guided as a replaceable wearing unit up to this separation point.

During operation, for example during a rotational movement about the third joint axis R3, a relative movement occurs between the various segments of the articulated-arm robot 2, and a pulling movement is exerted on the hose package 18. During the reverse movement back to the starting position, the hose package 18 must be retracted again.

In order to guide the hose package and, in particular, to perform this return movement, a guide device 20 is attached to the robot arm 2 in the vicinity of the second articulated joint R2. This guide device 20 includes a fastening clip 22 in which the hose package 18 is held, particularly in a form-locking manner, so that a restoring force exerted by the guide device 20 is transmitted to the hose package 18.

The guide device 20 has a support 24 with which it is fastened to the articulated-arm robot 2, particularly in the vicinity of the second articulated joint R2. When the hose package 18 moves, it—and with it the fastening clip 22—executes a particularly linear movement relative to the support 24. A return mechanism 25 is mounted on the support which exerts an elastic return force on the fastening clip 22. For this purpose, the fastening clip 22 is connected particularly to a sliding element (not shown in detail) which is attached to the support 24 in a linearly displaceable manner.

The protective hose 16 is often a so-called corrugated pipe in which the multiple cables 14 are typically loosely guided. The hose assembly 18 and, in particular, the protective hose 16 are wearing parts. If damage such as a tear in the protective hose 16, for example, is not detected early, this may lead to damage to the internal cables 14 and may result in an unwanted failure of the entire articulated-arm robot 2 and thus, for example, of an entire assembly cable within an industrial manufacturing process.

In order to achieve early detection of damage to the protective hose 16, the guide device 20 is now equipped with a sensor device 26, as will be explained in greater detail below with reference to FIGS. 2 to 4.

The depicted guide device 20 has, first of all, a guide unit 28. This includes a housing 30, which has the support 24 on the bottom side to which a housing cover 32 is attached. In the free interior space is formed a return mechanism (not shown in further detail here) which has an elastic return element, in particular a spring element, which exerts an elastic return force on a sliding element (not visible). The guide unit 28 has a fastening element 34 which is connected to the sliding element and is linearly displaceable along the support 24. In the exemplary embodiment, this fastening element 34 includes a bracket 36 which surrounds the housing cover 32 and engages into the interior space via lateral longitudinal slots and is connected there to the sliding element. The aforementioned fastening clip 22, in which the protective hose 16 is fixed in the mounted state, is attached to the bracket 36. In the exemplary embodiment, the guide unit 28 has a slideway at its front end which is connected in a stationary manner to the support 24 and through the use of which the hose package 18 is guided in a sliding manner.

During operation, the protective hose 16 and, with it, the fastening clip 22 as well as the entire fastening element 34 are therefore moved linearly back and forth along the guide unit 28 in order to make the compensating movement possible. The articulated-arm robot 2 is usually programmed for periodically recurring work sequences, for example in order to carry out multiple individual welding operations on a component within a duty cycle. The same duty cycle is repeated for the next component. Within such a duty cycle, the protective hose 16 and thus the fastening element 34 perform a defined movement pattern. Based on the movement pattern, it can be recognized whether the guide device 20 and/or the articulated-arm robot 20 are executing a correct movement sequence according to a target specification.

The sensor device 26 measures the movement sequence of the hose package 18, in particular the relative movement of the protective hose 16 relative to the support 24, and evaluates the movement data captured in the process.

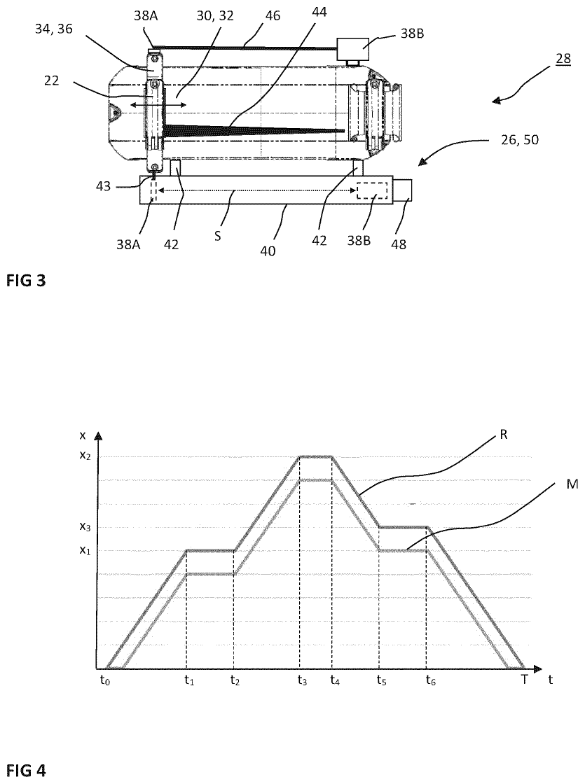

In principle, there are several options available for this, which are explained in greater detail below in connection with FIG. 2 or FIG. 3.

What all embodiments have in common is that the (linear) movement of the fastening element 34, in particular of the bracket 36, relative to the support 24 is detected and evaluated. The actual movement of the fastening element 34—and, with that, the actual movement of the protective hose 16—are thus measured directly.

For this purpose, the sensor device 26 has a first movable sensor component 38A and a second, stationary sensor component 38B. The movable sensor component 38A is fastened to the fastening element 34, whereas the stationary sensor component 38B is fastened to the support 24. The relative movement of the movable sensor component 38A relative to the stationary sensor component 38B is measured by the sensor device 26.

In several of the embodiments described below, the movable sensor component 38A is embodied as a reflector, and the stationary sensor component has a transmitter and, in addition, preferably also a receiver. A suitable sensor signal S is emitted via the transmitter which is reflected at the reflector and returned to the stationary sensor component 38B, where it is detected by the receiver. The current position of the movable sensor component 38A is evaluated, for example, by evaluating the propagation delay of the sensor signal S. A general explanation of the basic principle is given in connection with FIG. 2. The sensor signal S is preferably an ultrasonic signal. Alternatively, an optical signal is used.

In FIG. 3, which shows a top view of the guide device 20, several different variants of the sensor device 26 are shown in parallel side by side as examples. Usually, only one of these variants is used.

According to a first preferred embodiment, the sensor device 26 includes a sensor housing 40 which is disposed adjacent to the guide unit 28 and, in particular, is fastened thereto. The two sensor components 38A, 38B are disposed within the sensor housing 40. The sensor housing 40 and, in particular, the entire sensor device 26 are attached to the guide unit 28 by mounting elements 42. Alternatively, attachment to a component of the articulated-arm robot 2, such as the robot arm 8, is also possible.

The sensor housing 40 is preferably embodied as an at least largely closed housing so that the components located therein are protected from the environment. The sensor housing 40 is provided with a reversibly closable opening for inspection purposes, for example.

It should be emphasized that the movable sensor component 38A disposed in the sensor housing 40 is connected to the fastening element 34 and specifically to the bracket 36 via a connecting element 43 protruding from the sensor housing 40. The connecting element 43 therefore executes a movement relative to the sensor housing 40 during operation. It preferably has a longitudinal slot on one side wall for this purpose along which the connecting element 43 can move.

Particularly in the embodiment in which the ultrasonic signal is used as the sensor signal, the use of the sensor housing 40 is especially advantageous since undesired (spurious) reflections due to contours of the guide unit 28 and/or the articulated-arm robot 2 or other components in the surrounding area are avoided. Even with an optical sensor signal S, defined conditions of measurement are created by a closed sensor housing 40, thus ensuring reliable detection and measurement of the movement.

A sensor device 26 with an electrical detection principle based on a capacitive measurement is illustrated in the middle part of FIG. 3. In this embodiment, a stationary electrode 44 is formed with which a movable counter electrode (not shown in detail here) is associated which is connected in particular to the fastening element 34. In the exemplary embodiment, the electrode 44 is formed on the upper side of the housing cover 32. The counter electrode is formed, for example, on an underside of the bracket 36. In the exemplary embodiment, a provision is also made that the electrode 44 continuously changes its geometry in the longitudinal direction of the guide unit 28 and thus in the displacement direction of the fastening element 34. Specifically, it is embodied in the exemplary embodiment as a continuously tapered electrode 44. This results in the formation of a defined capacitance as a function of the current position of the fastening element 34, which therefore varies with the position. This capacitance is measured in an appropriate manner, and the current position is then determined. As an alternative to the illustrated continuous electrode 44, individual discrete electrodes may also be provided. As an alternative to a capacitive measuring principle, an inductive measuring principle is used.

Finally, in the upper part of FIG. 3, another embodiment with a mechanical measuring principle is shown; in this embodiment, a mechanical aid, in particular a cord 46, is connected to the fastening element 34. A stationary cord unit 48 is connected to the support 24. In particular, this stationary cord unit 48 has an integrated cord sensor (not shown in detail here) which detects the varying deflection of the cord 46 and thus the relative movement of the fastening element 34. A winding mechanism for the cord 46 is integrated for this purpose within the cord unit 48, which is spring-loaded, for example.

The movement data captured by the sensor device 26 are transmitted to an evaluation unit 48. This is preferably part of the sensor device 26 attached to the guide unit 28. It is preferably disposed on or in the sensor housing 40, as shown schematically in FIG. 3. It is generally attached in a stationary manner to the guide unit 28, for example, at least indirectly.

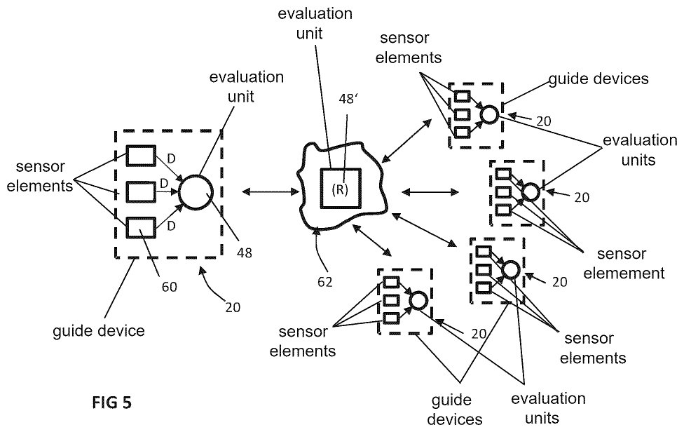

The evaluation of the movement data, as explained in greater detail below, particularly in connection with FIG. 4, is alternatively carried out in a remote evaluation unit, which is, for example, integrated into a system control system of the articulated-arm robot 2 or is part of a cloud-based solution.

Such a remote evaluation unit is also part of the sensor device 26, which in this case has multiple structural units or functional units that are disposed in a distributed manner. In such a case, the part of the sensor device 26 attached to the guide unit 28 is configured at least to emit a suitable communication signal for transmitting any processed measurement data to the remote evaluation unit.

FIG. 4 shows an exemplary curve of a deflection x relative to the time t of the protective hose 16. During a duty cycle, the protective hose 16 and, with it, the fastening element 34 perform a predefined movement pattern. Starting from a starting position at time to, a deflection occurs up to a first intermediate position x1 at a time t1. An initial processing step (welding) takes place here, for example, which takes a certain amount of time. After completion of this processing operation at time t2, another deflection to another intermediate position x2 takes place with a maximum deflection, for example, where another processing operation is carried out. Starting from there, the hose package 18 is returned to the original starting position x0 via another processing operation at an intermediate position x3, but at the end of the duty cycle (cycle time T).

The upper curve defines a target or reference pattern, which is formed by reference data R (a plurality of individual location-time pairs (xi, ti)).

During proper operation, a measured movement pattern formed by measured movement data B corresponds—up to permissible tolerances—to the reference pattern. In the event of faults, however, the measured movement pattern deviates from the reference pattern, so that the type of fault can and will be deduced from the deviations. This takes place within the evaluation unit 48.

This will be explained using the example of a tear in the protective hose 16: In the case of such a tear, the actual deflection of the protective hose 16 is usually less than the expected target deflection. This results in a position value that is lower than the target values being reached for the corresponding intermediate positions. In this case, the measured movement pattern is shifted downward in the negative x-direction, for example.

Depending on the application and the type of damage, a tear can also lead to a larger deflection or to a similar deflection but with other different movement characteristics.

In light of this, a large number of different parameters are determined, including derived parameters such as a variance, particularly of the deflection. This ensures a reliable and accurate evaluation and determination of the current movement situation.

In principle, other faults or errors can also be identified by evaluating the movement pattern and can be evaluated accordingly. If such a fault is identified by the evaluation unit 28, a warning signal is issued.

With the guide device 20 described herein with the sensor device 26 disposed thereon, damage to a protective hose 16 and/or any other fault can be detected at an early stage, and suitable countermeasures can be taken, such as issuing a maintenance message.

The sensor device 26 is configured in particular for retrofitting to existing guide units 28. A retrofit kit 50 is provided for this purpose which can be subsequently mounted on an existing guide unit 28. This retrofit kit 50 includes particularly the two sensor components 38A, 38B, preferably the evaluation unit 48 and/or at least one communication unit for transmitting data signals to a remote evaluation unit. Furthermore, the mounting elements 42 preferably belong to the retrofit kit 50. In the version with the sensor housing 40, this is part of the retrofit kit. The retrofit kit 50 preferably has a common assembly unit formed from these elements or is such an assembly unit. This is formed in particular of the sensor housing 40 and the mounting elements 42, the sensor components 38A, 38B already being contained pre-assembled within the sensor housing 40. In one variant, the evaluation unit 48 is also part of this assembly unit. In that case, only mounting on the guide unit 28 is required.

In connection with FIG. 5, a monitoring system and early warning system will be described below which serves for the continuous, regular checking of the condition of the protective hose 16.

The protective hose 16 in such guide devices 20 is normally subject to wear during operation. The frequently high stresses can also lead to damage to the protective hose 16. Both wear and damage impair the protective effect of the protective hose 16. If such a damaged or worn protective hose is not replaced in a timely manner, this may lead to a failure of the cables 14 guided in the protective hose and may result in a breakdown of the system and downtime. Especially in automated production systems in which articulated-arm robots 2 with such guide devices 20 are used, particularly in industrial environments, accessibility—for example for a visual inspection—is often not available or only available to a limited extent for safety reasons.

In order to now make a checking of the wear condition of the protective hose 16 possible, the monitoring system or early warning system according to FIG. 5 is provided.

This has at least one sensor element 60 and, in particular, multiple and even different sensor elements 60 which, during operation of the guide device 20, capture sensor data D and transmit them to an evaluation unit 48. In the embodiment of FIG. 5, this is the previously described evaluation unit 48 of the guide device 20, for example. Alternatively, an additional evaluation unit can be part of the guide device 20.

In the preferred alternative, an evaluation unit 48′ is disposed remotely from the guide device 20 and, in particular, also remotely from the articulated-arm robot 2. In that case, the individual sensor data D are transmitted, optionally after having already been processed, to this remote evaluation unit 48′. This is part of a cloud system 62, for example.

In general, the sensor data D are evaluated in the evaluation unit 48, 48′ for the current wear condition, as explained in the general part of the description.

The sensor data D are at least partially or exclusively sensor data D of the previously described sensor device 26, i.e., specifically the movement data M of the protective hose 16.

Preferably, additional, different sensor data D are captured and taken into account for the evaluation. These include, for example, temperature data for either the environment and/or the protective hose 16.

For the evaluation, the sensor data D or variables derived therefrom are preferably compared with reference data, in particular the previously described reference data R.

The acquisition of the sensor data D and the evaluation thereof takes place continuously during operation of the guide device 20, in particular at periodically recurring time intervals.

The reference data R are stored, for example, in the evaluation unit 48, 48′.

The reference data R are preferably derived from the acquired sensor data D during a learning phase. The learning phase is in particular a defined period of time, for example of several days, several weeks, or several years after commissioning of a (new) guide hose 16. Preferably, a learning phase is carried out again each time the guide hose 16 is replaced. In this way, the sensor data D are captured for the new state or for a certain period from the start of operation and are used as reference data R later on—i.e., during a monitoring phase following the learning phase. The directly determined sensor data D (raw data) or data derived therefrom or data obtained during further operation can be used as reference data.

Alternatively or in addition, the sensor data D from various guide devices 20 are captured in the remote evaluation unit 48′ in order to obtain the broadest possible database. General reference data R are then derived from these sensor data D, for example.

When comparing with the reference data, one variant checks whether a limit value (minimum/maximum) has been exceeded.

Alternatively, an evaluation algorithm is used in which, for example, an OK condition is learned as reference data through machine learning, specifically using AI (artificial intelligence) and while taking previous (historical) sensor data into account. This enables a failure of the protective hose to be detected with a high degree of accuracy.

After the detection of a failure of the protective hose 16, a warning message is issued and, for example, responsible persons are immediately informed. The warning is preferably transmitted automatically, for example through common communication channels such as email, SMS, etc.

Automatic detection and notification makes it possible to repair the protective hose promptly and prevent the destruction of the internal cables. The warning preferably already contains information relevant to the repair or replacement of the protective hose 16, such as part numbers. Maintenance time can be reduced as a result.

In one preferred refinement, a status image of the respective system (e.g., guide device 20 or entire articulated-arm robot 20) is created and preferably also displayed graphically, for example as a dashboard, so that the current conditions of the entire system can be seen.

The following is a summary list of reference numerals and the corresponding structure used in the above description of the invention:
2 articulated-arm robot
4 base
6 rocker
8 robot arm
10 robot hand
12 processing tool
14 cable
16 protective hose
18 hose package
20 guide device
22 fastening clip
24 support
25 return mechanism
26 sensor device
28 guide unit
30 housing
32 housing cover
34 fastening element
36 bracket
38A movable sensor component
38B stationary sensor component
40 sensor housing
42 mounting element
43 connecting element
44 electrode
46 cord
48 evaluation unit
50 retrofit kit
60 sensor elements
62 cloud system
R1 1st articulated joint
R2 2nd articulated joint
R3 3rd articulated joint
S sensor signal
R reference data
M measured movement data
D sensor data

1. A guide device for guiding at least one cable or at least one cable of an articulated-arm robot disposed within a protective hose, the guide device comprising:
a guide unit having a static support and a fastening element for fastening the protective hose, said fastening element being movable along said static support to enable a compensating movement of the protective hose and of the at least one cable guided in the protective hose; and
a sensor device configured to at least indirectly measure a movement of the protective hose, during operation with the protective hose mounted, and to thereby capture movement data of the protective hose.

2. The guide device according to claim 1, which further comprises an evaluation unit configured to evaluate the movement data captured during the measurement for a deviation from reference data, said evaluation unit configured to evaluate the captured movement data for at least one of a fault in a movement sequence of said guide unit or a change in a movement pattern of said guide unit.

3. The guide device according to claim 2, wherein said evaluation unit is configured to detect the movement pattern of said guide unit during a duty cycle and to compare the movement pattern with a reference pattern, and within a scope of the duty cycle, said guide unit and the protective hose performing a defined movement pattern and moving from a starting position via at least one intermediate position at which a processing operation takes place to an end position and, from the end position, back again to the starting position.

4. The guide device according to claim 3, wherein the reference pattern and the movement pattern are based on the same periodically recurring duty cycle.

5. The guide device according to claim 2, wherein said evaluation unit is configured to evaluate the captured movement data for damage to the protective hose and for an occurrence of tears.

6. The guide device according to claim 3, wherein:
said evaluation unit is configured to evaluate the captured movement data for damage to the protective hose and for an occurrence of tears; and
said evaluation unit is configured to infer damage to the protective hose based on a comparison of a deflection at the intermediate position or the end position between the reference pattern and the measured movement pattern.

7. The guide device according to claim 1, wherein said sensor device has two sensor components for measuring the movement of the protective hose, one of said two sensor components is at least indirectly connected to the protective hose and another of said two sensor components is disposed in a stationary manner, causing said two sensor components to perform a relative movement during operation.

8. The guide device according to claim 7, wherein said one sensor component is connected to said fastening element.

9. The guide device according to claim 8, wherein said one sensor component is a reflector for a sensor signal to be measured.

10. The guide device according to claim 7, which further comprises a sensor housing, said two sensor components being housed at least partially in said sensor housing.

11. The guide device according to claim 10, wherein said sensor housing is mounted laterally adjacent to said guide unit.

12. The guide device according to claim 10, wherein said sensor housing is fastened to said support.

13. The guide device according to claim 7, wherein said sensor device is selectively configured:
for an ultrasonic measurement, and said one sensor component has an ultrasonic transmitter, or
for an optical measurement, and said one sensor component has an optical transmitter, or
for an electrical or electromagnetic measurement or a capacitive measurement.

14. The guide device according to claim 1, wherein said sensor device has a mechanical auxiliary element or a cord connected at least indirectly to the protective hose and to said fastening element, and said sensor device is configured to measure a movement of said mechanical auxiliary element.

15. The guide device according to claim 1, wherein said guide unit has an integrated return mechanism configured for an automatic, spring-actuated return of the protective hose into a starting position, said return mechanism being mounted on said support, said guide unit having a housing cover, and said fastening element having a bracket engaging around said housing cover.

16. A retrofit kit for forming the guide device according to claim 1, the retrofit kit comprising said sensor device configured to be mounted on said guide unit and configured to measure the movement of the protective hose of said guide unit.

17. A method for monitoring a movement of a protective hose of a guide device serving to guide at least one cable disposed in the protective hose, the method comprising:
providing the guide device, the guide device having a guide unit with a fastening element for fastening the protective hose and a static support, the fastening element being movable along the static support to enable a compensating movement of the protective hose and of the at least one cable guided in the protective hose;
measuring a movement of the protective hose relative to the static support and capturing movement data; and
measuring a movement pattern of the protective hose and comparing the movement pattern with a reference pattern.

18. The method according to claim 17, which further comprises checking the protective hose for damage based on the measured movement data.

19. The method according to claim 17, which further comprises:
using at least one sensor element to repeatedly capture sensor data and evaluating the sensor data for a wear condition of the protective hose; and carrying out at least one of:
a) processing the sensor data using a filter algorithm to filter out at least one of noise components, interference signals, or irrelevant signal components and obtain filtered sensor data;
b) extracting predefined characteristic values from the filtered sensor data using an extraction algorithm, and deriving a current wear state based on the extracted characteristic values.

20. The method according to claim 19, which further comprises at least one of:
a) selecting the predetermined characteristic values from a progression of the sensor data over time, and using a minimum or a maximum of the progression as a characteristic value;
b) subjecting the sensor data to a statistical evaluation, and using a statistical characteristic value or a variance or a standard deviation of the captured sensor data as a characteristic value.
